(19) United States
(12) Patent Application Publication
(10) Pub. No.: US 2015/0044415 A1
(43) Pub. Date: Feb. 12, 2015

(54) Articles of Cellulose and Methods of Forming Same

(71) Applicants: John B. Read, San Diego, CA (US); Daniel Sweeney, Burbank, CA (US)

(72) Inventors: John B. Read, San Diego, CA (US); Daniel Sweeney, Burbank, CA (US)

(21) Appl. No.: 13/964,617

(22) Filed: Aug. 12, 2013

(51) Int. Cl. B32B 29/00; D04H 3/015; D21J 7/00; D21H 11/00; D21J 3/00; D03D 15/00; D04H 3/013

(52) U.S. Cl. CPC B32B 29/005; D03D 15/0072; D04H 3/015; D04H 3/013; D21H 11/00; D21J 3/00; D21J 7/00; B32B 2317/18; D10B 2201/00
USPC 428/116; 428/131; 442/181; 428/292.1; 442/327; 428/535; 162/231

(57) ABSTRACT

The present invention follows from a number of recent discoveries relating to cellulose fibrils and crystals. Unique properties of these compositions provide for novel structural materials that exhibit extremely high strength per unit of mass. Structures and articles first taught herein may be formed by computer numerically controlled processing, extruding, molding, shearing, weaving, and various additive manufacturing techniques, as well as by other more traditional procedures. These structures and articles may be used as a skin or core in composite constructions. These structures and articles can be used as free standing shells or panels. They may be made into intricate forms, particularly in three spatial dimensions with sonic elements in tension and some elements in compression to realize high performance functionalities. Cellulose matter is a dominate part of these compositions, making the articles fully biodegradable. One can make entirely renewable and nontoxic products depending on the presence of necessary additives.

### BACKGROUND OF THE INVENTION

### Field

The following invention disclosure is generally concerned with articles and methods of forming said articles and more specifically concerned with forming articles and structures from microfibrillated cellulose. Further, forming complex or intricate shaped articles and structures in three dimensions via various methods such as 3D printing, weaving, and origami style folding of specific substrates, among others.

Paper in the largest sense consisting of pulped plant fiber constructions where mechanical or chemical means have removed most of the lignin in the fiber goes back to the late Stone Age and includes materials such as bark cloth and so called papyrus paper. Paper in the modern sense appears as a Chinese invention. Paper also occurs in nature where insects known as paper wasps produce it, interestingly in three dimensional forms.

Three dimensional paper constructions of human provenance also have long history. People have produced papier-mâché of the traditional sort since roughly 3000 BCE. East Asian artisans generally coated the material with multiple layers of insect or sumac based lacquer to produce a hard lustrous surface, and to provide water proofing.

During the early modern era European craftsman became sought to emulate and improve upon the Asian product and to mass produce the material in a factory setting. Production on an industrial scale began first in France and then in England, spanning a period from the middle of the eighteenth century to the end of the nineteenth century, by which time industrial output of the material practically ceased.

### Fabrication—Historical

Mass produced papier-mâché took many forms, some of them under comprehensive patent protection in their countries of origin, but, as the name might suggest, it almost always began with a paper feedstock such as linen or cotton rags.

### Layered Forms

Major vendors commanded bodies of trade secrets including proprietary recipes and special procedures devoting whole factories to the manufacturing of papier-mâché. The industrial papier-mâché products of the nineteenth century included light, strong, and relatively inexpensive domestic furniture, coachwork, wallboard, utensils, and works of art. They fell out of favor largely due to changing fashions in furniture and due to the emergence first of celluloid, a tough cellulose based product produced by chemical pretreatment of the cellulose slurry, and later of inexpensive sheet steel and aluminum as well as formable thermoplastics.

### Paper Yarn

Paper yarn or twine provides example of prior art in three dimensional paper based structural materials. Paper yarn consists of long narrow strips of paper tightly twisted into filaments. Paper yarn developed in the nineteenth century still sees use as cordage and also in the manufacture of paper braid used in making hats.

### Paper Wicker

Paper wicker, the third example of prior art in three dimensional paper constructions, lies midway between papier-mâché and paper yarn in terms of fabrication technology. Unlike paper yarn, and like papier-mâché, paper wicker comes directly from a pulp slurry containing adhesives and sizing; it resembles paper yarn in form in that it consists of twisted strands. The strands themselves weave together to create a tough, resilient fabric used for making wicker furniture. Its manufacture constitutes a small artisanal industry today. As substitutes for reeds, rushes, or rattan in the construction of wicker furniture that industry extends back to the beginning of the twentieth century using flattened cords.

Precursor Models

Paper yarn and paper wicker provide a model for advanced structural forms and materials utilizing MFC. Modern three dimensional looms and braiding machines permit the realization of extremely complex preforms made of such materials and capable of serving as walls or cabinet panels and of assuming almost any shape.

### Origami

Origami-like structures comprised of paper, the last three dimensional paper constructions to consider among the prior art, arose as an art form in East Asia centuries ago, reaching the highest level of sophistication in Japan. Toward the end of the twentieth century mathematicians and architects began to study the structural characteristics of folded paper constructions, including them within the larger category of developable surfaces that incorporate Gaussian curvatures subject only to bending or folding operations and without stretching or cutting. Such structures exhibit membrane effects whereby incident loads translate into in-plane compressive forces within sheets of structural material, thus exploiting its material properties to the fullest.

One may fashion such developable surfaces of flexible paper by the simple act of bending or folding, or may be molded to shape or otherwise fabricated out of more rigid materials. The category of developable surfaces stands hierarchically higher and more inclusive than the first three; papier-mâché, paper yarn, and paper wicker as well as flat paper could form into developable surfaces. Boat building over a period of decades, and more recently architecture, has utilized developable surfaces comprised of plywood or sheet metal.

### Related Systems

Yano et al of U.S. Pat. No. 7,378,149 teach of “High Strength Material Using Cellulose Microfibrils” Yano forms articles in molding processes and includes molded elements having a weight between 65 and 100% with respect to cellulose microfibrils. Molding systems have been used for various types of article formation using most types of fiber as bulk matter from which molding is based. Molding like that presented by Yano includes some disadvantages not found in other types of processes used to create useful articles having improved attributes. In one such example, articles having a density dependent upon spatial variables is not readily possible to achieve with common molding systems.

The same team of Yano et al also present in their recent disclosure of Jan. 3, 2013 “Molding Material and Manufacturing Method Therefor”. In this teaching, one can discover additional techniques of producing various types of paper and particularly those incorporating microfibrillated cellulose as a primary component. Microfibrillated cellulose yields an advantageous strength property to these papers and that is recognized in the work taught throughout that important related description.

Kowata et al present a fiber composite and systems to achieve same which anticipate cellulose fiber of about 30 nm (nano or microfibrillated). Kowata further teaches uniform distribution of fiber to assure articles of highly regular structure. However, Kowata does not account for those types of systems where distributed density variations are desirable.

Berglund et al present “Strong Nanopaper” in their invention description of Aug. 30, 2012 as US Patent Application Publication 2012/0216718. Berglund and others teach using clay and microfibrillated cellulose nanofibres having orientation in preferred geometries to achieve accompanying results. Berglund continues with teachings of nanopaper and uses of nanopapers. Berglund further includes interesting scientific measurement relating to the variation with respect to the ratio of material clay and MFC and the physical attributes observed for those combinations.

Axrup et al teach in their invention disclosure about paper and paperboard substrate and processes related to same. Specifically, polymer layers are proposed to be used in conjunction with layers comprising microfibrillated cellulose to produce a high performance end product with desired barrier properties.

While systems and inventions of the art are designed to achieve particular goals and objectives, some of those being no less than remarkable, these inventions of the art have nevertheless include limitations which prevent uses in new ways now possible. Inventions of the art are not used and cannot be used to realize advantages and objectives of the teachings presented herefollowing.

### SUMMARY OF THE INVENTION

Comes now, John Read and Daniel Sweeney with an invention of articles, structures and methods of forming same of unique compositions of cellulose matter including those articles and methods used to form them. It is a primary function of these teachings to provide for new objects formed of special cellulose matter. In particular, it is an objective to provide for new high strength paper, paper like matter, paper structures, paper constructions, and paper articles of particular composition, including those characterized as microfibrillated cellulose. It is a contrast to prior art methods and devices that systems and articles first presented herein do not suffer the deficiencies and shortcomings of common paper and paper articles as articles and methods of the invention are arranged in view of uses of particular matter and its assembly in prescribed manner. A fundamental difference between paper and paper articles of the instant invention and those of the art can be found when considering its composition with regard to the high proportionate quantity of micro fibrillated cellulose and MFC.

The present invention provides for articles of manufacture composed of MFC including components of a structural nature (mini/micro paper structures), means for utilizing MFC within a practical and flexible structural material and further methods of forming such articles and structures. In spite of its demonstrably extremely strong and stiff characteristics on the micro level, prior attempts to use it in structural composites have proved so far unsuccessful by artisans having attempted uses of MFC in this manner. Because of MFC's highly favorable cost benefit ratio it has the potential of displacing many traditional structural materials across a range of applications, but only by means of exploiting MFC's superior mechanical properties on a macro scale.

### Dimensional Constraints of Existing MFC Art

Past attempts to use MFC in structural composites have been based primarily on the model of FRPs (fiber reinforced plastics). These consist of strong synthetic fibers such as fiberglass, aramid fiber, and carbon fiber immersed in a thermoplastic resin matrix. Often the FRP is bonded to a low mass, high volume core to exploit the superior tensile strength of synthetic structural fibers. The core may consist of a thermoplastic foam or a honeycomb made from paper, metal, petroleum based plastic, or from woven synthetic fibers.

That model works for purposes of maintaining continuity in an existing fabrication system, but utterly fails to optimize MFC for a number of reasons. MFC cannot be spun into long straight filaments by any conventional means in a cost effective manner, attempts to do so have resulted in fibers of only moderate tensile strength because it confines the extensive interlocking of fibrils, which forms the basis of the material strength, to a single dimension. Of equal importance, MFC will not form strong bonds with industrial thermoplastics without the presence of additives, which complicates handling and unacceptably increases manufacturing costs.

Worse, the ‘skin on core’ architectures characterizing FRP construction sub-optimize MFC; MFC readily lends itself to complex hierarchical free standing architectures where a reinforcing internal space frame and a cellular skin structure integrally conjoin as a monocoque. This makes separate core material unnecessary.

Accordingly, it is highly desirable to bring forth a solution of fabrication based on handling and processing techniques appropriate for production of paper, paper like structures, micro and macro structures, and other MFC components, rather than synthetic fibers. Processing techniques and methods of fabrication include computer numerical controlled ‘printing’, molding, pressing, stamping, and extruding of aqueous slurries containing MFC into flat or three dimensional continuous structures in which contouring or shaping further strengthens an article so as to distribute mechanical loads throughout the structure.

An alternative solution involves the preparation of a paper yarn from MFC and use of such yarn to construct three dimensional textiles by means of 3-D weaving, braiding, or knitting. Such paper textiles may also be shaped into developable surfaces. Articles and structures so formed enjoy several advantages over similar articles made from high modulus synthetic fibers. These articles and structures require no favored geometry. Net shape or near net shape parts easily result from any desired geometry, including curved and planar forms and resist bending and shear forces.

Manufacturing processes require no volatile solvents or mineral spirits, resulting in a zero emissions process which are favorable to the environment. Methods of this teaching particularly improves responsible manufacturing principles for sustained us of naturally available resources. Manufacturing processes produce very little waste. Essentially the molded material incorporates all of microfibril input. Unused input recycles immediately without modification nor preperation. Conservation of matter further improves the environmental advantages brought about by these techniques and uses of these special materials.

These materials may be comprised one hundred percent of recyclable renewable bio-based feedstocks. It accepts ordinary kraft process wood pulp derived from rapidly growing commercial softwoods, as well as bacterially derived cellulose. Waste paper, saw dust, and crop residues also provide suitable feedstocks. These processes do not require resins nor adhesives to consolidate the fibrils when forming via various techniques like weaving and printing, and eliminates possibility of delamination as these articles and structures do not include matrix to delaminate. Integrity of these articles and structures is not compromised by surface abrasions as found with articles formed of fiber reinforced plastics or FRP. Manufacturing costs including energy consumed during exercise of manufacturing processes is lower than for competing fiber reinforced plastic compositions that use synthetic petrochemical based fibers. This consideration is again another benefit for environmental conservation. When used as base materials for fabrication of compound devices or articles, these materials can be easily screwed, glued, sawed, and sanded using standard wood working tools and technique.

Microfibrils inherently lack any predominate axial orientation or other directional biases, and thus consolidate mass equally in all directions. However strategic distribution of additives within the mass of structural material may impart anisotrophies in a manner to achieve prescribed benefit where desirable.

A slurry of MFC may be combined with suitable additives such as silica powder to improve compressive strength. Other cooperation with certain compatible materials permits a range of property enhancements.

Three dimensional structures comprised primarily of MFC material are not limited to molded or extruded parts. MFC may be formed into long fibers which then form the basic structural units for three dimensional forms.

### OBJECTIVES OF THE INVENTION

It is a primary object of the invention to provide new high-strength two and three dimensional paper articles.

It is further an object of the invention to provide new high performance articles of manufacture made of microfibrillated cellulose.

It is a further object to provide methods of forming articles made from microfibrillated cellulose.

It is an object of the invention to form high-strength laminated paper articles.

It is additionally an object to form three dimensional articles and structures of superior strength.

It is also an object of the invention to provide for computer numerically controlled methods of forming three dimensional articles from microfibrillated cellulose matter.

A better understanding can be had with reference to detailed description of preferred embodiments and with reference to appended drawings. Embodiments presented are particular ways to realize the invention and are not inclusive of all ways possible. Therefore, there may exist embodiments that do not deviate from the spirit and scope of this disclosure as set forth by appended claims, but do not appear here as specific examples. It will be appreciated that a great plurality of alternative versions are possible.

### GLOSSARY OF SPECIAL TERMS

Throughout this disclosure, reference is made to some terms which may or may not be exactly defined in popular dictionaries as they are defined here. To provide a more precise disclosure, the following term definitions are presented with a view to clarity so that the true breadth and scope may be more readily appreciated. Although every attempt is made to be precise and thorough, it is a necessary condition that not all meanings associated with each term can be completely set forth. Accordingly, each term is intended to also include its common meaning which may be derived from general usage within the pertinent arts or by dictionary meaning. Where the presented definition is in conflict with a dictionary or arts definition, one must consider context of use and provide liberal discretion to arrive at an intended meaning. One will be well advised to error on the side of attaching broader meanings to terms used in order to fully appreciate the entire depth of the teaching and to understand all intended variations.

### Microfibrillated Cellulose

Common uses in related literature has denominated materials described herein as ‘microfibrillated cellulose’ or MFC. For purposes of this disclosure, MFC is intended to also include sub ‘micro’ structures e.g. nano structures are intended to be included as part of any definition of ‘microfibrillated cellulose’. Terms relating to the sub-micron or nano-scale should also be considered within the meaning of microfibrillated cellulose. MFC materials may include composition of (1) nanofibrils, (2) fibrillar fines, (3) fiber fragments and (4) fiber. Thus the term MFC does not equate to nanofibrils, microfibrils or any specific cellulose nano-structure, though it may incorporate each of these.

### Origami

Articles and structural elements formed from folded substrates of microfibrillated cellulose are referred to herein as ‘origami derived structures’. Complex shapes in three dimensions yield special strength:weight properties and these are included in origami methods of forming these articles.

### Computer Numerically Controlled

Any method driven by microprocessor or other electronic means of distributing material in a pattern not spatially uniform, is for purposes of this specification considered a computer numerically controlled method of forming articles and structures.

### DETAILED DESCRIPTION OF THE INVENTION

### Structural Nature of Cellulose

Complex, hierarchically ordered assemblage of progressively larger bundles of fibers fused together by linkages of hemicelluloses, lignin, and pectin characterize cellulose as a component of living creatures. Cellulose whiskers and crystals consisting of chains of saccharides measuring nanometers in cross-section and tens of nanometers in length comprise the basic building blocks. Such whiskers can link together to form longer filaments called fibrils, non-crystalline amorphous cellulose form these linkages. The fibrils themselves form bundles, and each bundle measures in the hundreds of nanometers in length. These nanofibrils can interlink to form longer filaments known as microfibrils, and these in turn can further bundle and link lengthwise to form the short cellulose fibers that provide the scaffolding for woody plants. At the highest level of hierarchy, lignin provides compressive strength. The chart herefollowing tabulates these concepts by size.

Components of microfibrillated cellulose

| Diameter (μm) | Biological structures | Technological terms |
|---|---|---|
| 10 to 50 | Tracheid | Cellulose fibre |
| <1 | Macrofibrils | Fibrillar fines, fibrils |
| <0.1 | | Nanolibril, nanofibres |
| <0.035 | Microfibril | |
| 0.0035 | Elementary fibril | |

Terms and sizes according to terminology and morphology reported in the literature.

The bundles themselves present a frayed appearance when examined with imaging techniques of appropriate resolution, and tiny bristles extend out in all directions from an elongated central body. The bristles from proximate micro or nano-fibrils may interlock with one another, forming strong mechanical bonds.

Cellulose, at the foundational levels of the crystal, has tensile strength exceeding that of all other known materials with the exception of carbon nanotubes. At the level of the nanofibrillated fibril tensile strength may exceed 400 MP while Young's modulus or bending stiffness may exceed 20 GP. These figures approximate those of the strongest commercial hydrocarbon based fiber such as aramid and carbon fibers. Larger cellulosic structures appearing in living forms have, however, considerably less tensile strength due to the presence of weaker materials of lignin and hemicellulose, and due to the increasing proportion of relatively disordered amorphous cellulose that compromises tensile strength. At successively higher levels of hierarchical organization, cellulose structures assume a great number of forms with widely varying physical properties.

### Structural Properties Derivation

The superior structural properties of MFC arise from two factors—the aforementioned extensive entanglement of the fibrils and the consequent distribution of mechanical loads over the entire structure, and the inherent strength of the cellulose long chain molecules.

### Value—New Class of Structural Materials

Cellulose at a low level of hierarchical complexity may serve for the production new class of structural materials. Nanocrystalline cellulose (NCC, or sometimes CNC) and MFC both potentially constitute such novel structural materials. NCC falls within this disclosure only when used within novel architectures of our own devising since much prior art exists in using NCC.

Distinction between Forms

Cellulose crystals by themselves cannot form into larger structures. They can only provide reinforcing matrices for polymer plastics or water based latexes, which they accomplish by impeding crack propagation rather than by providing structural reinforcement. Nano-fibrils and micro-fibrils, on the other hand, may matt together to form papers, however, and can form the basis of structural materials consisting largely or entirely of material characterized as such.

Such structural materials may take the form of laminated or consolidated paper constructions. They will preserve the form and visual appearance of paper but will exhibit markedly different physical properties, specifically strength and durability.

Papier-mâché Greatly Improved, Yarns & Twines, Origami

One can consider some such constructions, that is microfibrillated cellulose of a purified nature matter together to effect increased entanglement between fibers as greatly improved forms of traditional three dimensional paper compositions, namely, papier-mâché. This refers especially to the industrial product of the eighteenth and nineteenth centuries, used primarily as a substitute for wood. But unlike traditional papier-mâché formulations, which use the same feed-stocks as conventional sheet papers, this new material utilizes highly refined and/or purified MFC—the product of newly developed industrial processes. It is important to note that only minor refinement also produces measurable results. Some versions of these articles may be formed where purification levels only slightly increase the amount of MFC with respect to that which is formed in naturally occurring matter.

### Core of the Innovation —3-D MFC

The key to utilizing MFC for new classes of structural applications lies in three-dimensional fabrication including, but not limited to, so-called additive manufacture. 3-D printing and 3-D weaving and braiding stand chief among these. The proportion of MFC to other materials can vary, since not all will require the full characteristics of pure MFC.

Other three dimensional paper compositions include paper yarn or twine, paper braid and paper wicker, which also have extensive prior histories in industry, as well as origami-like folded constructions which have existed in art objects for centuries but which only recently have found expression within industrial products.

The innovation includes compositions where the three dimensional paper or improved papier-mâché contains a proportion of microfibrillated cellulose that is less than 100% but is greater than 20%. The other components of the three dimensional paper may include ordinary kraft paper pulp of the sort used in most paper manufacturing today, or long fibers of the sort seen in specialty papers of superior strength. Such long fibers may include abaca, hemp, coir, bamboo, raffia, banana leaf, jute, linen, and cotton, among others. Preferred fibers include abaca, jute, and bamboo because of their relatively low cost and superior tensile strength. In process, this involves pulping and commingling with the MFC in slurry, or, alternately spun into lengthy filaments in a separate process and intertwined with the MFC paper yarn after drying and consolidation.

Bacterial micro and nano cellulose that have different molecular properties than MFC and somewhat different performance attributes MFC may also mix in the formulation in varying proportions. Several species of cyanobacteria excrete MFC in industrial volumes, though not for structural applications (fuel stock). It has been used as a bulking agent in certain prepared foods; as a wound dressing, and in specialized paper, especially for loudspeaker cones.

### Law of Mixtures not Applicable

Nanocrystalline cellulose, the elementary form of cellulose that itself consists of sequences of simple sugars may reinforce three dimensional paper formulations utilizing MFC. Such crystalline rods have tensile strength approaching that of carbon nanotubes, and reinforcements of as a little as 2% by volume have resulted in large increments of tensile strength within a number of matrices in other words, the blend does not obey the law of mixtures but instead the properties of the nanocrystals preponderate at very low proportional levels, while incorporating tensile strength of MFC.

### Novel Articles of Manufacture and Structures

Innovations first taugh and described herein lie as much in the way fabricators form the material within industrial processes and in the resulting the microstructures as in the final applications. The processes, mostly additive in nature, include
1. three dimensional printing and extrusion,
2. three dimensional textile fabrication such as weaving, knitting, and braiding.
3. laminated object manufacturing, and
4. stamping and subsequent forming of sheets with various bending machines.

Microstructure architectures include
1. monocoque structural skins with advanced regular cellular forms which include interior tensegrity forms
2. repetitive micro thin shell lattice;
3. conic shell trusses, origami like developable forms, and
4. combinations thereof.

Fabricators may position these microstructures within macro structures of almost any geometry.

This represents the first attempt to use purified MFC within periodic cellular materials. Such materials may also exhibit fractal hierarchy.

Macro structures constructed in this manner may form: panels, struts, girders, planks, and structural members of almost any shape.

Because of the relatively low cost and high strength of underlying material, MFC, and because the microarchitectures exploit those properties optimally and utilize membrane effects to minimize material consumptions, the resulting structural forms may serve as low cost load bearing architectural members as well as supporting and enveloping structures for almost any product that currently employ thermoplastics, sheet metal, or advanced composites.

This invention is anticipated to include three dimensional paper formulations based upon microfibrillated cellulose containing additives and additions such as nano-clay or silica so as to form nano-composite materials, as well as interleaved sheets of entangled carbon nanotubes.

The presence of additives may be graduated along any dimension of a three dimensional paper construct so as to cause the mass to become anisotropic, that is, having properties which vary dimensionally such as absorbance, refractive index, conductivity, tensile strength, among others. Engineers may vary physical properties from the surface to the interior of the mass or along any other spatial dimension. They can thus endow the mass with varying stiffness, Young's modulus or elasticity, fracture strength or toughness, surface hardness, susceptibility to fatigue, sound transmission velocity, self-damping, and thus precisely tailor to specific applications.

Three dimensional microfibrillated paper formulations may be used as structural materials in architecture, and for protective cases, ballistic armor, resonators for musical instruments, interior and exterior body panels for vehicles, and as substitutes for thermoplastics across a plurality of comparable applications.

Today, a hundred and more years after the collapse of the traditional papier-mâché industry, wood chemistry has much advanced over its state at that time, making the physical properties and chemical composition of cellulose well understood. The basis exists for the design and fabrication of papers of tremendous tensile strength which in turn may serve as the basis of a thoroughly updated versions of papier-mâché, paper yarn, and paper wicker which can vie with synthetic fibrous materials comprised of long chain polymers or pure elemental carbon in terms of tensile strength and stiffness to mass ratio. The key to producing such enhanced paper based materials lies in utilization of microfibrils containing a minimum of amorphous cellulose.

In this innovation microfibrils comprise the fundamental structural material in a number of different types of structural papers having such form factors described herein.

One embodiment extends the naturally occurring entanglement of the microfibrils from two to three dimensions so that extensive entanglement occurs in depth, and such that the material becomes largely isotropic with similar mechanical and structural properties in all dimensions.

Another embodiment twists flat strips of MFC paper into a yarn and subsequently weaves, braids or knits the yarn into complex, structurally stable three dimensional forms.

In another embodiment, a solution containing MFC and various additives directly forms into a material resembling papier-mâché, taking the shape of reeds or withies. This too subsequently weaves or braids into complex three dimensional forms.

A Structural Three-Dimensional Inflexible Composition of MFC with or without Additives.

Such a material, which forms a coherent, compacted mass of essentially any shape, superficially resembles the industrial papier-mâché of the nineteenth century, but, in its most basic form, requires no adhesives or other additives. It instead relies entirely upon the tendency of the microfibrils to agglomerate, to inter-tangle, and to support one another. Because the microfibrils mechanically link to one another, the structure eliminates fiber to fiber delamination. Such binding thereby distributes incident forces over a wide surface area so that a significant area of the material participates in opposing such forces. The material thus resists rupture or disintegration of the material because the tensile strength of the material includes the sum of that of all of the interlinked fibrils in the entire mass.

During the fabrication process the microfibrils themselves suspend in all aqueous solution or slurry of the sort and composition commonly seen in conventional paper making. This allows for the uniform dispersal of the fibrils so that they achieve a uniform density within the final product.

As a fluid of moderate viscosity the aqueous solution conforms to the contours of the vessel it occupies, making it highly suitable for molding, stamping, or pressing, as well as to extrusion. Compacted within a hot press of a flat profile, the solution forms flat sheets resembling conventional paper in appearance. Compressed within shaped molds, the solution will form into thickened shapes in the form of panels, or in the form of curved shapes, including compound curves. Curves may include parabolic, Gaussian, hyperbolic, or spherical, among others. In assuming some of these curves the material may exhibit membrane effects such that incident loads translate entirely into compressive and shear forces.

Alternatively, the solution may first form into flat paper sheets that fabricators may then consolidate by means of laminated object manufacturing techniques. This process lays down strips of adhesive backed paper consisting of nano-fibrils in layers upon a supporting substrate and consolidates them by a hot roller that compresses the paper and cures the adhesive. A cutting laser or blade then applied to each layer creates variegated contoured surfaces and volumes, including undercuts. Preferably this process employs adhesives composed of lignin derived from the cellulose separation process. Since lignin and cellulose bond well naturally and with lignin as a hydrophobic material, such use seals otherwise hydrophilic cellulose, serving two purposes.

The compacting process exposes the solution to heat sufficient to vaporize and expel the water producing bone dry and entirely solid material at the completion of the process. Density will suppress the natural hydrophilic tendencies of cellulose and prevent water molecules from migrating into the depths of the material.

The compacting process occurs over the span of minutes or hours, and involves high pressures and temperatures as high as 400 degrees Celsius. In a molding process it excludes air from the compacting chamber or mold.

Because of the utter lack of rigidity or self-supporting properties in the solution itself, it many only utilize female molds in the consolidation process.

The resulting MFC papier-mâché will exhibit tensile strength and a Young's modulus comparable to those of such high strength structural fibers as carbon fiber, aramid fiber such as Keylar and Twaron, polyethylene fibers such as Spectra and Dyneema and polypropylene fibers such as Tegris, but at fractional cost.

Process to Produce a Flat, Hierarchically Convoluted Structure from Partially Consolidated MFC Paper by Means of Stamping

Stamping permits the realization of complex and intricate surface contours which support membrane effects under structural loads. Developable surfaces based upon repetitive corrugations or folds or double corrugations (with corrugations crossing one another) derived from architectural origami provide examples of such forms. Double corrugations and other complex folding patterns in a core structure are means of improving rigidity per unit of mass.

Introducing hierarchy into the organization of folding patterns produces further improvements. Each facet produced by the initial and largest folding pattern a smaller pattern will improve the mechanical stiffness of each individual facet. This process can extend several levels deep for the same purposes. These sub-patterns may bear a fractal relationship to the first and largest folding pattern, or may diverge and may represent different folding patterns and developable forms.

Such hierarchical organization produces a performance multiplier, augmenting the rigidity of the overall structure per unit of mass, and for each additional level of hierarchy the multiplier increases by approximately one. Thus three levels of hierarchy result in minimally a threefold improvement in stiffness to mass ratio.

Removing material from the center of each facet within the hierarchical organization will produce a further improvement in stiffness to mass ratio. This process, beginning from the largest facets to progressively smaller facets within the initial facets produces a system such that edges alone bear mechanical loads.

In similar manner, stamping may also produce flat honeycomb structures with vertically aligned cavities.

### A Three Dimensional Printed Form Consisting of MFC.

In a process known as ‘three dimensional printing’ the material may also extrude in the form of layer upon layer additions. The printer must have provisions for heating the slurry as it extrudes. In this embodiment the desired structures build layer by layer by the print head in any desired geometry, using only heat for consolidation. Three dimensional printing, unlike laminated object manufacturing which it otherwise resembles, represents a purely additive manufacturing process characterized by the absence of any initial coherent material stock. As with molding or macro extrusion, the production of the structural material and the finished form occur within a single process. Such an additive process can produce virtually any geometric form. Composition of the solution itself may vary ‘on the fly’ to promote anisotropic structural properties. In this process all floating structures require support by removable scaffolding until the entire mass has hardened.

In the past such 3-D printing confined use to prototypes, custom made products, and low series production—its established uses today. Recently, 3-D printing techniques have extended to the building trades where semiautonomous extrusion robots have successfully fabricated large scale free forms in concrete. 3-D printing of MFC may scale up for similar purposes.

Three Dimensional Construction Based on MFC Yarn or MFC Wicker Structural Units and Formed by Three Dimensional Looms or Braiding Machines.

Flat paper of conventional composition may be twisted into a yarn, and a small industry currently exists for the production of such paper based yarns.

Paper yarn exhibits greater tear resistance and effective tensile strength than the sheet paper that comprises it, and demonstrates a proven means of creating long, strong fibers out of pure cellulose. Use of MFC paper in paper yarn in lieu of conventional papers results in cords of far greater tensile strength that one can use as the basis for creating complex three dimensional structures with a high degree of dimensional stability.

Such microfibrillated paper yarn may be woven, knitted, or braided into three dimensional forms using modern numerically controlled (CNC) looms and braiding machines of established design. These three dimensional textiles may include standalone structures or may serve as internal reinforcements within a mass of microfibrillated papier-mâché where in the past fabricators have used meshes composed of fiberglass or steel for reinforcement.

Such microfibrillated paper yarns may also form the basis of resin impregnated composites. Synthetic fiber reinforced composites have been used in 3-D textiles but never paper yarn, and certainly never microfibrillated paper yarn.

3-D textiles can be used to weave, knit, or braid into almost any conceivable form including trusses, tensegrity structures, lattice shells, developable structures, and other open-work forms where the preponderance of the internal volume consists of empty space but where the structural strength of the three dimensional form is equal to or greater than that of a solid mass of the same volume. Such structures constitute complex monocoques where skin and core merge together and micro-architectures distribute incident forces across the structure.

3-D textiles may be formed into open-work cores of various geometries; those cores may interweave with coherent skins so that a single continuous fabric forms both the core and the skin, eliminating delamination concerns.

3-D weaving, knitting, and braiding by means of numerically controlled machinery result in high speed additive manufacturing processes; these permit economical mass production and rapid prototyping, custom one-offs, and low series production. The process does not support sub-millimetric feature sizes thus limiting hierarchy to a small extent, but will produce floating free form structures without supporting scaffolding.

The process permits 3-D braided preforms without lamination, while woven and knitted structures generally require adhesives for stability. Lignin based resins are especially compatible with cellulose, and eliminate the problem of disposing of lignin as a waste product at the pulping facility. Lignin also imparts compressive strength to textile constructions. Well characterized vacuum assisted resin infusion processes can apply lignin resin.

Microfibrillated cellulose may also be electro-spun to produce long fibers. In this process the fibers to be joined are given opposing electric polarities such that they become electrets and attract to one another and bond permanently.

Within the scope of this invention, microfibrillated paper based yarns may also be pultruded or manually deposited within molds in the form of layup, or cemented to light weight cores in sandwich structures.

### Process Combinations

A three dimensional structure fashioned with hybrid fabrication processes from MFC and featuring some combination of the following techniques: molding; stamping; laminated object manufacturing; printing; and textile techniques including weaving, braiding, and knitting.

Such hybrid constructions will likely possess intricate internal structures that vary according to depth. Fabrication technique will be chosen as to their suitability for producing the particular macro or micro structure present in any segment of the construction.

Distinction between Nanocrystalline Cellulose and Microfibrillated Cellulose

This innovation utilizes both elementary forms of cellulose, but concerns itself primarily with microfibrillated cellulose that consists of short sections of nano cellulose crystal linked by bridges of amorphous cellulose.

Nanocrystalline cellulose (NCC, or sometimes CNC), the most elementary form of the cellulose polymer macro molecule, takes the form of rods measuring a few nanometers in length and consists of chains of hexose and pentose sugars in repetitive sequences. Such rods exhibit extremely high stiffness and tensile strength, but have limited usefulness in structural applications in pure form because they cannot readily join into larger structures. Their chief utility consists in providing reinforcements within bodies of other materials, and we propose to use them in that manner. Mixing small percentages of such crystals into slurries of microfibrillated cellulose MFC, significantly improves mechanical properties of the latter, sometimes by a full order of magnitude in terms of stiffness and tensile strength.

In contrast to NCC, MFC fibrils themselves can form into two and three dimensional papers with isotropic properties, and in such constructions the fibrils tend to reinforce one another. MFC paper will find u use in a multitude of structural applications.

### Computer Numerically Controlled Fabrication of Articles and Structures

Numerically controlled industrial processes use sequences of instructions, generally in the form of digital data, and the instructions execute automatically by machine tools responding to coded electrical inputs; power and information transmit simultaneously in the same stream, or a signaling protocol controls an electrical power source. These industrial processes permit the construction of complex forms without the use of molds or skilled human operators, with complexity carrying with it little or no price premium.

In the case of a material such as MFC, numerically controlled fabrication processes permit the construction of periodic cellular materials where the presence of a complex internal support structure or space frame situated between two skins lends strength without adding appreciable mass. Such structures leverage the intrinsically good mechanical properties of cellulose to realize structural members that far outperform monolithic constructions while actually costing less to manufacture if numerically controlled processes are used.

Moreover, labor costs decline dramatically from the use of such processes since they seldom require human intervention.

### Lamination

Lamination here refers to the process of joining flat strips of paper—in this case, MFC paper—together to form three dimensional accretions.

There are two primary methods of achieving these laminated articles.

The first uses an established LOM (laminated object manufacturing) process which practitioners have hitherto applied only to conventional paper stocks, and not papers comprised of MFC or MFC with NCC reinforcements.

This process includes the following steps.

1.) Manufacture MFC paper by conventional processes, including the preparation of a slurry from an MFC gel or a MFC powder mixed into a preponderance of water, NCC may also be added in single digit percentages to the slurry, making sure it disperses well.

2.) The slurry is placed on a fine mesh in such a matter that solid fibrils will accumulate densely on its surface.

3.) Remove the mesh with consolidated MFC resting upon its surface from the slurry tank, and reduce the MFC to a bone dry state by a further application of heat. The consolidated sheets or strips undergo further densification with the application of more heat and pressure.

4.) Place the resulting paper strips, which have very high strength and tear resistance, on a feed spool which communicates with a take up spool. Apply a coating of adhesive, preferably derived from lignin, to both sides of the paper. Preferably the adhesive itself will contain a loading of MFC and NFC to provide strength and reinforcement.

5.) Pass the paper over a table and under a cutting laser or blade communicating with a microprocessor containing design files.

6.) The blade or laser removes paper according to a predetermined pattern, and immediately expose the paper to a hot roller that dries the adhesive and joins the paper strip to an underlying paper strip.

7.) Waste paper scrolls onto the take up spool. By incrementally varying the profile of the strips layer by layer, the LOM machine may produce three dimensional objects of almost any degree of intricacy, inducting those having open sections, compound curves, and sharp edges.

In addition, we employ an innovative embellishment of this process where the paper making process and the object formation process consolidate and become in effect a single process.

Instead of beginning with formed paper, this alternative fabrication technique utilizes an extrusion head to lay down a micro cellulose slurry of uniform thickness upon a supporting table in whatever two dimensional pattern is desired. These patterns may be based on stored definitions recorded as data files.

1.) A hot press descends upon the finished layer, residing above it for an interval sufficient to expel most of the water from the slurry and extensively entangle the fibrils, creating an expanse of paper which retains some moisture.

2.) The extrusion head adds another layer which may possess an incrementally varying profile. In this manner the machine builds up a three dimensional object layer by layer. This process requires no removal of waste paper, though it may require some reductive finishing of the form to achieve net shape.

This fabrication technique may be construed as a specialized form of three dimensional printing, although it includes a compacting and heating process not present in typical 3-D printers.

### Fabrication of Three-Dimensional Textiles Comprised of MFC Paper Yarns

Three dimensional textiles represent an emergent technology within the advanced composites industry and currently come into play primarily as solid preforms used as reinforcements within conventional skin-on-core composite constructions.

A novel and proprietary construction process integrates skin and underlying support into monocoque structures. One may weave, knit, or braid three dimensional textiles. Since the presence of crimp in the fiber weakens them, flat weaves have greater strength than textiles with interlacing. Undirectional fabrics in cross-ply arrangements and with no stitches provide the strongest embodiment, but require adhesive bonding between layers. Braided three dimensional structures oar two unique benefits, namely the distribution of incident forces over a wide area, and the possibility of entirely eliminating adhesives or resins.

One may produce 3-D textiles in a single more or less continuous process, or by stitching together layers of two dimensional fabrics, with single production process preferred.

A 3-D loom in its most basic form is a two dimensional loom with a second shuttle that moves vertically up and down. Beyond that almost any degree of complexity is possible, and some advanced designs have harnesses which can vary orientation of individual warp threads as well as multiple shuttles that permit the realization of open work forms such as tubes and cavities, and curvilinear shell structures.

Three dimensional looms of various forms have been used to make specialized fabrics including those with piles. The looms now figuring in the production of advanced composites are in fact modified textile looms of established mechanical design. They differ from their earliest predecessors in that they are numerically controlled by high speed microprocessors; however, numerically controlled looms of one sort or another go back to the eighteenth century and constitute the earliest instance of factory automation.

Uses of MFC paper yarn with respect to weaving processes, to produce periodic cellular materials and monocoque structures embodying them are entirely new and first taught here. Nevertheless, yarns may be made out of twisted paper that will retain the mechanical properties of the paper itself. The innovations comprise use of mechanically ultra-strong paper comprised of MFC, said paper being matter from which yarn is formed and used in weaving processes.

Weaving with MFC based yarns may be realized in the following steps:

1.) shedding where MFC warp threads are lifted;

2.) weft insertion, where MFC threads having a 90% orthogonal relationship to the weft are inserted amidst the MFC weft threads;

3.) beat-up where the MFC warp threads are brought back down; and

4.) take-up where the finished MFC based fabric is wound around a take-up spool. The take-up phase would be altered when dealing with the outputs of 3-D looms since that output could be rigid and could take any number of forms.

3-D braiders do not differ in any definitive way from the traditional 2-D sort. The design is essentially similar, but more spools and carriers are present, and they are widely distributed across a plane so that many yarns may be combined in a single structure. In a sense all braids are three dimensional, and a designated three dimensional braid simply has more strands in more intricate interrelationships than its two dimensional counterpoint.

Defining discrete manufacturing steps is even more difficult in the case of a 3-D braider than in the case of a 3-D loom. Braiding is a truly continuous process and incorporates but a single mechanical action, the intertwining of the fibers or filaments forming the braid. There is no warp and weft, nor is there a sequence of shedding, insertion, and beat-up procedures. Automated braiding machines, whether 2-D or 3-D, produce braids by varying the speed and winding direction of individual pieces of yarn, and by changing the entry point of the individual yarn into the braid by rotating a notched wheel called a horn gear. The yarn passes through the notch and proceeds from there to the point where it intersects with other pieces of yarn which is dependent upon the position of the notch. Just by varying these few parameters, three dimensional shapes of almost any geometry are possible.

Whether the three dimensional textile is the product of a loom, a knitting machine or a braider, a means of forming high strength MFC based yarn is required, and so the first step important in any of these processes is the production of a suitable yarn. Predecessors attempting to produce cellulose based filaments suitable for textiles have utilized either electro-spinning or extruders to form the filament. In neither case have experimenters yet succeeded in fashioning filaments of comparable strength to those comprised of high modulus carbon or aramid fibers. Tencel and Lyocell, trade names for commercial fibers spun from MFC, do not manifest nearly the mechanical strength of the individual fibrils of which they are comprised, and are weaker than glass fibers or ballistic nylon.

To make ultra-strong paper we repeat the first three steps in the laminated object manufacturing process. For step number 4, we insert long, narrow strips of paper in a winding machine which simply gives the strips a tight twist. Such machines are series produced and are used to produce commercial quantities of ordinary paper yarn today. The resulting yarn is stretched on a harness or wound on spools and fed out to be formed into three dimensional fabrics in the fifth step—if we choose to consider the weaving or braiding to be single step processes. As we have seen, weaving could conceivably be categorized as a three step process.

### Stamping

The stamping process permits production of structural paper in net forms, with developable or lattice shell surface geometries, in a single rapid process. Such stamped structural papers would however have to join together in larger structures and consolidate with skins in order to produce periodic, cellular materials, however. This would require robotic machinery of unique design, stampers themselves lacking any such capabilities.

### Folding Machines and Robots

Many developable forms may be realized by means of folding operations. The production of corrugated cardboard and paper honeycomb both involve mechanized folding procedures. In order to produce very strong developable forms by such means, the operator must modify such equipment to make double corrugations. Such corrugations could be fractal in nature for additional stiffness, and would require numerical control of the machinery in order to execute folding sequences on different physical scales.

The production of such developable forms resembling origami art is not necessarily a step by step process, but is more continuous by nature.

One will now fully appreciate how one may use microfibrillated cellulose to form novel articles and structures. Specifically, three dimentional forms of very high strength and durability. In particular, these may be achieved via special process methods including but not limited to: weaving, origami substrate folding, and 3-D printing of microfibrillated cellulose in various forms. Although the present invention has been described in considerable detail with clear and concise language and with reference to certain preferred versions thereof including best modes anticipated by the inventors, other versions are possible. Therefore, the spirit and scope of the invention should not be limited by the description of the preferred versions contained therein, but rather by the claims appended hereto.

What is claimed is:

1) Articles comprising micro fibrillated based paper having a tensile strength two orders of magnitude greater than that of pulp based papers, and one order of magnitude greater than papers containing a preponderance of long strong plant fibers such as jute, kenaf, hemp, mulberry bark, etc.

2) A three dimensional article comprised of the paper of claim 1, further characterized as having three dimensional entanglement of fibrils and inherent isotropic structural properties.

3) A three dimensional article comprised of the paper of claim 1, provided with spatial distributions of additives whereby structural properties either locally or globally are modified.

4) A three dimensional article comprised of the paper of claim 1, said article comprising structure with pronounced and intricate surface features produced by stamping.

5) A three dimensional article comprised of the paper of claim 20, said article formed by laminating two dimensional strips and cutting the resulting aggregate to shape.

6) A three dimensional article comprised of the paper of claim 1, said article formed by successive layer additive printing of an MFC slurry.

7) A three dimensional article comprised of the paper of claim 6, said successive layer additive printing is characterized as a computer numerically controlled process.

8) A three dimensional article comprised of the paper of claim 7, said computer numerically controlled process is characterized as 3D printing.

9) Three dimensional articles of claim 1, formed of microfibrillated cellulose paper twisted into a yarn and woven into a prescribed shape.

10) Articles of claim 9, yarn is electro spun and comprised of microfibrillated cellulose substitute for paper yarn in three dimensional textiles.

11) Articles of claim 1, further comprising fiber reinforced composite where cellulose yarns join together by a cellulose resin.

12) Articles of claim 1, further comprising a fiber reinforced composite where cellulose yarns consolidate by charging tows with opposing electrical polarities such that they cling together without resin.

13) Articles of claim 1, further comprising a fiber reinforced composite comprising of pultrusion where cellulose yarns composed of microfibrillated cellulose form three dimensional structures.

14) Articles of claim 1, further comprising a fiber reinforced composite formed from a slurry composed of water and microfibrillated cellulose as a medium for three dimensional printing

15) Articles of claim 1, further comprising a fiber reinforced composite formed from a slurry composed of water and microfibrillated cellulose as a medium for micro extrusion.

16) Articles of claim 1, further comprising a hybrid structure of a plurality of elements each of those elements having been formed of either process characterized as being from the group including: weaving, printing, extruding, molding, laminating, pressing, and stamping.

17) Articles of manufacture formed of microfibrillated cellulose, said articles are formed as three dimensional periodic structures.

18) Articles of claim 17, said periodic structures include anisotropic distributions of material.

19) Articles of claim 17, said periodic structures are characterized as including a mechanical truss system.

20) Articles of claim 1, said woven microfibrillated cellulose is characterized as a weave comprising a plurality of spun or twisted fibers.

21) Articles of manufacture comprising microfibrillated cellulose formed in a printing process.

22) Articles of manufacture of claim 21, said articles are characterized as three dimensional structures.

23) Articles of manufacture of claim 22, said structures include material anisotropies.

24) Articles of manufacture of claim 23, said material anisotropies are characterized as material densities.

25) Articles of manufacture of claim 24, said material anisotropies are characterized as binder densities.
